(19) United States
(12) Patent Application Publication
(10) Pub. No.: US 2021/0189212 A1
(43) Pub. Date: Jun. 24, 2021

(54) CONTROL CURE THERMALLY-CONDUCTIVE GAP FILLER MATERIALS

(71) Applicant: 3M INNOVATIVE PROPERTIES COMPANY, St. Paul, MN (US)

(72) Inventors: Jenny B. Werness, Saint Paul, MN (US); Simone Jurjevic, Neuss (DE); Siegfried R. Goeb, Willich (DE); Peter Bissinger, Diessen (DE); Wolf Steiger, Geretsried (DE); Jeremy M. Higgins, Roseville, MN (US); Jens Eichler, Kaarst (DE)

(21) Appl. No.: 17/055,220

(22) PCT Filed: May 10, 2019
(86) PCT No.: PCT/IB2019/053877

§ 371 Date: Nov. 13, 2020

Related U.S. Application Data
(60) Provisional application No. 62/670,917, filed on May 14, 2018.

(51) Int. Cl. C09K 5/14; C08K 9/04; C08K 3/22; C08K 3/08; C08K 7/18; C08K 5/521; C08K 13/06; C08L 71/02; H01M 50/264; H01M 10/613; H01M 10/653; H01M 10/6551

(52) U.S. Cl. CPC C09K 5/14; C08L 2203/20; C08K 3/22; C08K 3/08; C08K 7/18; C08K 5/521; C08K 13/06; C08L 71/02; H01M 50/264; H01M 10/613; H01M 10/653; H01M 10/6551; C08K 2201/001; C08K 2201/014; C08K 2003/2296; C08K 2003/0812; C08L 2201/02; C08K 9/04

(57) ABSTRACT

Control cure thermally-conductive gap filler materials are described, as are methods of curing. Also described are curing agents and methods of making curing agents.

### FIELD

The present application relates to control cure thermally conductive gap filler materials.

### SUMMARY

In one aspect, the present application relates to a curing agent comprising zinc tosylate deposited onto a particle of zinc oxide. The application also relates to methods of preparing the curing agent, control cure thermally-conductive gap filler materials that include the curing agent, and methods of preparing such control cure thermally-conductive gap filler materials.

The control cure thermally-conductive gap filler materials described herein may be suitable for use in electronic applications such as battery assemblies.

### BRIEF DESCRIPTION OF THE DRAWINGS

FIG. 1 illustrates the assembly of an exemplary battery module according to some embodiments of the present disclosure.

FIG. 2 illustrates the assembled battery module corresponding to FIG. 1.

FIG. 3 illustrates the assembly of an exemplary battery subunit according to some embodiments of the present disclosure.

FIG. 4a-4c are scanning electron microscope images of zinc oxide, a curing agent as described herein, and stochiometric zinc tosylate crystals.

### DETAILED DESCRIPTION

In one aspect, the present inventors have determined that the use of certain curing agents allows for the making of control cure materials. These systems are also more efficient curing systems than prior art systems, which provide for the use of stoichiometric zinc tosylate as opposed to the curing agents described herein. Such controllable efficient curing characteristics may be extremely important in any process where automated assembly requires such control. For instance, during the production process of battery cells and assemblies, battery cells and assemblies may be manipulated in space (e.g., moved, turned, etc). Such movement requires some degree of stability in the gap filler materials to ensure that they do not creep or otherwise deform in an unpredictable way.

The need to predict the cure properties, and by extension the flow properties (e.g., viscosity) of the control cure thermally-conductive gap filler materials, represent an important need in the industry for producing such battery cells and battery assemblies. Furthermore, minimizing manufacturing steps and increasing the ease of handling of component materials is highly desirable. Achieving this control cure while minimizing the solid additives can be beneficial in terms of cost, product complexity and can allow for high loadings of thermally-conductive fillers (enabling the achievement of higher thermal conductivity). These needs are addressed by the curing agents described herein.

By thermally conductive materials it is meant that the material has a thermal conductivity of more than 1.5 W/mK, but the upper end of the range is not particularly limited.

The curing agent described herein comprises zinc tosylate deposited onto a particle of zinc oxide. This is distinguished from a stoichiometric zinc tosylate crystal, which is a 1:2 salt (i.e., Zn(Tos)₂). As demonstrated herein, the cure characteristics of a curing agent comprising zinc tosylate deposited on to a particle of zinc oxide shows a reasonably predictable behavior (pot life and cure time) and is more efficient than curing with stoichiometric zinc tosylate (that is, similar cure characteristics can be achieved with smaller amounts of curing agent).

When stoichiometric zinc tosylate crystals are used, it has been observed that they should be ground to a consistent size in order to give predictable cure characteristics. For the present curatives described herein, the zinc tosylate is on particles of zinc oxide. Therefore, there is no need to grind the curatives before use. This leads to easier handling, more efficient manufacturing, predictable cure characteristics and more efficient curing.

As used herein, a control cure material is one wherein the pot life (time to initiate cure) and/or the curing time may be consistently controlled by varying the concentration of curing agent. Furthermore, because there is no need to grind the curatives before use, they exhibit more predictable cure characteristics, more efficient manufacturing, and easier handling.

When a flame retardant plasticizer is described herein as a liquid, it is meant that the plasticizer is a liquid under its conditions of use. For instance, if a composition is being formulated at 25° C. and 1 atmosphere of pressure, then the flame retardant plasticizer is a liquid under such conditions.

The thermally-conductive gap filler described herein is particularly suitable for use in batteries and battery assemblies, specifically the types of batteries used in electric and hybrid electric automobiles. The usefulness of the compositions, however, is not so limited. The thermally-conductive gap filler described herein may find use wherever such materials are used, for instance, in electronics (e.g., consumer electronics, server cooling) applications.

Thermal management plays an important role in many electronics applications. For example, proper thermal management of battery assemblies contributes to addressing challenges in performance, reliability and safety. This includes both first level thermal management where battery cells are assembled in a battery module, and second level thermal management where these modules are assembled into battery subunits or battery systems. Thermal management can also be important in the cooling of battery control units, as well as in non-battery electronic applications.

Currently, thermal management for battery assemblies relies on curable-liquid gap fillers or pads. The curable liquids flow during assembly and can adjust to dimensional variations before being cured. Also, the liquids can be applied at the time of assembly allowing greater design flexibility.

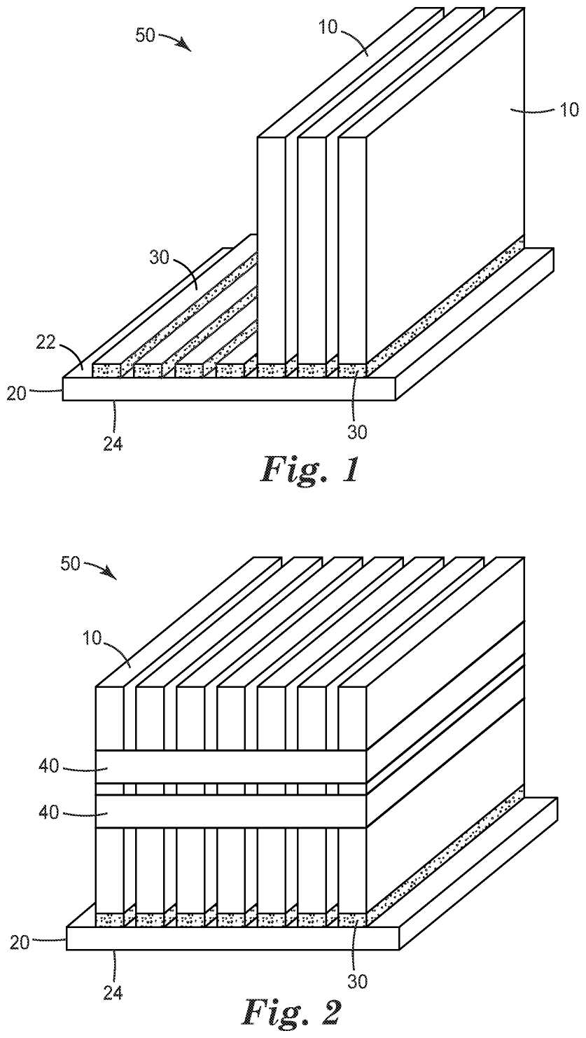

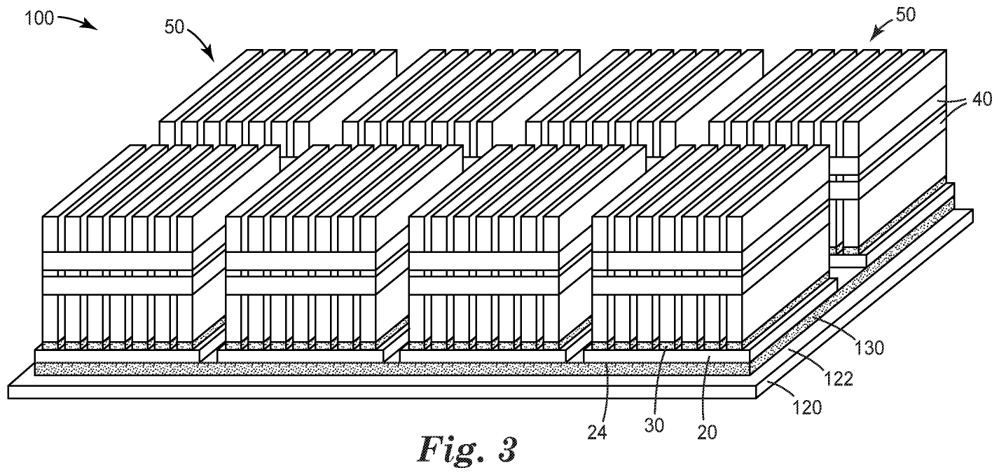

Components of a representative battery module during assembly are shown in FIG. 1, and the assembled battery module is shown in FIG. 2. Battery module 50 is formed by positioning a plurality of battery cells 10 on first base plate 20. Generally, any known battery cell may be used including, e.g., hard case prismatic cells or pouch cells. The number, dimensions, and positions of the cells associated with a battery module may be adjusted to meet specific design and performance requirements. The constructions and designs of the base plate are well-known, and any base plate (typically metal base plates) suitable for the intended application may be used.

Battery cells 10 are connected to first base plate 20 through first layer 30 of a first thermally conductive gap filler according to the present disclosure. As described herein, such control cure thermally-conductive gap filler compositions may comprise a matrix polymer, a thermally-conductive filler, and a curing agent comprising zinc tosylate deposited onto a particle of zinc oxide.

First layer 30 of the first thermally conductive gap filler provides first level thermal management where the battery cells are assembled in a battery module. As a voltage difference (e.g., a voltage difference of up to 2.3 Volts) is possible between the battery cells and the first base plate, breakthrough voltage may be an important safety feature for this layer. Therefore, in some embodiments, electrically insulating fillers like ceramics (typically alumina and boron nitride) may be preferred for use in the first thermally conductive gap filler.

In some embodiments, layer 30 may comprise a discrete pattern of the first thermally conductive gap filler applied to first surface 22 of first base plate 20, as shown in FIG. 1. For example, a pattern of gap filler corresponding to the desired lay-out of the battery cells may be applied, e.g., robotically applied, to the surface of the base plate. The first layer may be formed as a coating of the first thermally conductive gap filler covering all, or substantially all, of the first surface of the first base plate. Alternatively, the first layer may be formed by applying the first thermally conductive gap filler directly to the battery cells and then mounting them to the first surface of the first base plate.

During the assembly step illustrated in FIG. 1, the first thermally conductive gap filler is not yet fully cured. This allows the individual battery cells to be positioned and repositioned as needed to achieve the desired layout. The rheological behavior of the not-fully-cured thermally conductive gap filler aides in allowing the gap filler to flow and accommodate the dimensional variations (tolerances) within and between individual battery cells.

In some embodiments, the gap filler may need to accommodate dimensional variations of up to 2 mm, up to 4 mm, or even more. Therefore, in some embodiments, the first layer of the first thermally conductive gap filler is at least 0.05 mm thick, e.g., at least 0.1 mm, or even at least 0.5 mm thick. Higher breakthrough voltages may require thicker layers depending on the electrical properties of the gap filler, e.g., in some embodiments, at least 1, at least 2, at least 3, at least 4, or even at least 5 mm thick. Generally, to maximize heat conduction through the gap filler and to minimize cost, the gap filler layer should be as thin as possible, while still ensuring good (thermal) contact with first base plate 20. Therefore, in some embodiments, the first layer is no greater than 6 mm thick, e.g., no greater than 5 mm thick, or even no greater than 3 mm thick.

In some embodiments, the control cure thermally-conductive gap filler exhibits shear thinning behavior in its uncured state. This can assist in the uniform application of the gap filler by, e.g., spray, jet, or roll coating. This rheological behavior may aide in allowing the gap filler to be applied using conventional robotic techniques. Shear thinning may also aide in easing the positioning of the individual battery cells by allowing easier movement while still holding the cells in place before final cure is achieved.

As the control cure thermally-conductive gap filler cures, the battery cells are held more firmly in-place. Thus, it is important to be able to predict and control the so-called pot life of the gap filler. Further, when curing is complete, the battery cells are finally fixed in their desired position, as illustrated in FIG. 2. Accordingly, in order to better automate the manufacturing process, it is important to be able to also predict and control the so-called curing time.

Additional elements, such as bands 40 may be used to secure the cells for transport and further handling.

Generally, it is desirable for the thermally conductive gap filler to cure at typical application conditions, e.g., without the need for elevated temperatures or actinic radiation (e.g., ultraviolet light). In some embodiments, the first thermally conductive gap filler cures at no greater than 30° C., e.g., no greater than 25° C., or even no greater than 20° C. Of course, this does not mean that higher or lower temperatures are not available in the manufacturing process, and cure time can be decreased or increased with the use of higher or lower temperatures, respectively. Also, the cure temperature may be varied throughout the cure process in order to control the cure properties.

Depending on the manufacturing requirements, the time to cure is no greater than 72 hours, no greater than 48 hours, or even no greater than 24 hours. The time to cure may even be no greater than 60 minutes, e.g., no greater than 40 minutes, or even no greater than 20 minutes. Although very rapid cure (e.g., less than 5 minutes or even less than 1 minute) may be suitable for some applications, in some embodiments, an open time of at least 5 minutes, e.g., at least 10 minutes, or even at least 15 minutes may be desirable to allow time for positioning and repositioning of the battery cells. Furthermore, depending on the manufacturing process details, it may be important that the cure actually has an open time of at least 60 minutes, at least 90 minutes, or even at least 2 hours.

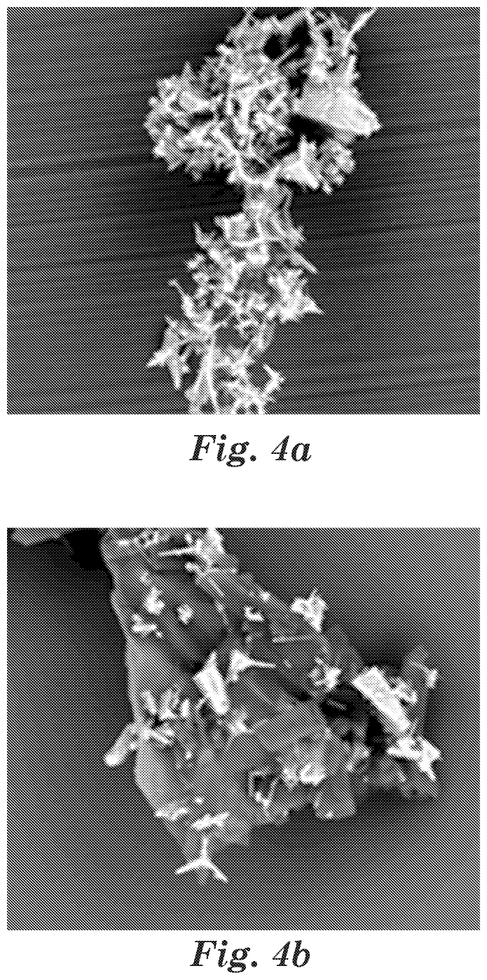

As shown in FIG. 3, a plurality of battery modules 50, such as those illustrated and described with respect to FIGS. 1 and 2, are assembled to form battery unit 100. The number, dimensions, and positions of the modules associated with a particular battery subunit may be adjusted to meet specific design and performance requirements. The constructions and designs of the second base plate are well-known, and any base plate (typically metal base plates) suitable for the intended application may be used.

Individual battery modules 50 are positioned on and connected to second base plate 120 through second layer 130 of a second thermally conductive gap filler, which may be a control cure thermally-conductive gap filler containing the curing agent described herein.

Second layer 130 of a second thermally conductive gap filler is positioned between second surface 24 of first base plate (see FIGS. 1 and 2) and first surface 122 of second base plate 120. The second thermally conductive gap filler provides second level thermal management where the battery modules are assembled into battery subunits. The second thermally conductive gap filler may be a control cure thermally-conductive gap filler. Further, at this level, breakthrough voltage may not be a requirement. Therefore, in some embodiments, electrically conductive fillers such as graphite and metallic fillers may be used, alone or in combination with electrically insulating fillers like ceramics.

The second layer 130 may be formed as a coating of the second thermally conductive gap filler covering all or substantially all of first surface 122 of second base plate 120, as shown in FIG. 3. Alternatively, the second layer may comprise a discrete pattern of the second thermally conductive gap filler applied to the surface of the second base plate. For example, a pattern of gap filler corresponding to the desired lay-out of the battery modules may be applied, e.g., robotically applied, to the surface of the second base plate. In alternative embodiments, the second layer may be formed by applying the second thermally conductive gap filler directly to second surface 24 of first base plate 20 (see FIGS. 1 and 2) and then mounting the modules to first surface 122 of second base plate 120.

During the assembly step, the second thermally conductive gap filler is not yet fully cured. This allows the individual battery modules to be positioned and repositioned as needed to achieve the desired layout. As the second thermally conductive gap filler continues to cure, the battery modules are held more firmly in-place, until they are finally fixed in their desired position. Thus, it is important to be able to predict and control the so-called pot life and cure times of the gap filler.

The second thermally conductive gap filler may exhibit shear thinning behavior in its uncured (or not fully cured) state. This can assist in the uniform application of the gap filler to the surface of the second base plate by, e.g., spray, jet, or roll coating. This rheological behavior may aid in allowing the gap filler to be applied the surface of the second base plate using conventional robotic techniques, or may aid in easing the positioning of the individual battery modules by allowing easier movement while still holding the modules in place before final cure is achieved.

Starting with a liquid, uncured thermally conductive gap filler also aides in allowing the gap filler to flow and accommodate varying dimensional variations (tolerances) within and between individual battery modules. Therefore, in some embodiments, the layer of second thermally conductive gap filler is at least 0.05 mm think, e.g., at least 0.1, or even at least 0.5 mm thick. In some embodiments, thicker layers may be required to provide the required mechanical strength, e.g., in some embodiments, at least 1, at least 2, at least 3, at least 4, or even at least 5 mm thick. Generally, to maximize heat conduction through the gap filler and to minimize cost, the second layer should be as thin as possible, while still ensure good contact. Therefore, in some embodiments, the second layer is no greater than 5 mm thick, e.g., no greater than 4 mm thick, or even no greater than 2 mm thick.

Generally, it is desirable for the thermally conductive gap filler to cure at typical application conditions, e.g., without the need for elevated temperatures or actinic radiation (e.g., ultraviolet light). In some embodiments, the first thermally conductive gap filler cures at no greater than 30° C., e.g., no greater than 25° C., or even no greater than 20° C. Of course, this does not mean that higher or lower temperatures are not available in the manufacturing process, and cure time can be decreased or increased with the use of higher or lower temperatures, respectively. Also, the cure temperature may be varied throughout the cure process in order to control the cure properties.

Depending on the manufacturing requirements, the time to cure is no greater than 72 hours, no greater than 48 hours, or even no greater than 24 hours. The time to cure may even be no greater than 60 minutes, e.g., no greater than 40 minutes, or even no greater than 20 minutes. Although very rapid cure (e.g., less than 5 minutes or even less than 1 minute) may be suitable for some applications, in some embodiments, an open time of at least 5 minutes, e.g., at least 10 minutes, or even at least 15 minutes may be desirable to allow time for positioning and repositioning of the battery cells. Furthermore, depending on the manufacturing process details, it may be important that the cure actually has an open time of at least 60 minutes, at least 90 minutes, or even at least 2 hours.

The assembled battery subunits may be combined to form further structures. For example, as is known, battery modules may be combined with other elements such as battery control units to form a battery system, e.g., battery systems used in electric vehicles. Additional layers of thermally conductive gap filler according to the present disclosure may be used in the assembly of such battery systems. For example, thermally conductive gap filler according to the present disclosure may be used to mount and help cool the battery control unit.

In addition to the properties discussed above (e.g., cure time, open time, and rheological behavior), gap fillers can provide desirable thermal and mechanical properties. For example, the thermally-conductive gap fillers provide the desired level of thermal conductivity. In the first level thermal management, a thermal conductivity of at least 1.5 W/mK (Watt per meter×Kelvin) may be desired, e.g., at least 2.0, at least 2.5, or even at least 3.0 W/mK.

Even higher thermal conductivities may be desirable for the second level thermal management, e.g., at least 1.5 W/mK (Watt per meter×Kelvin) may be desired, e.g., at least 2.0, at least 3.0 W/mK, at least 5 W/mk (e.g., at least 10 or even 15 W/mK).

Generally, the selection and loading levels of the thermally-conductive fillers are used to control the thermal conductivity. Factors such as the selection of the matrix polymer (considering its rheological properties), and the presence of solids other than the thermally-conductive filler, may have a significant influence on the maximum achievable thermally-conductive filler loading. In some embodiments, thermally-conductive filler loadings of at least 50% by volume (vol. %), e.g., at least 60, at least 65, or even at least 70 vol. % may be achievable while maintaining an acceptable viscosity.

The viscosity of the thermally-conductive gap filler as well as the component materials (when prepared from multiple component systems) should be chosen based upon the manufacturing needs. In general, a lower viscosity of the thermally-conductive gap filler material (precursor and/or the material itself), when in its not yet fully cured, may aid the manufacturing process.

The selection of the polymer used to form the thermally-conducting gap filler plays a major role in controlling one or more of (i) the rheological behavior of the uncured layer; (ii) the temperature of cure (e.g., curing at room temperature); (iii) time to cure profile of the gap filler (open time and cure time); (iv) the stability of the cured product (both temperature stability and chemical resistance); (v) the softness and spring back (recovery on deformation) to ensure good contact under use conditions; (vi) the wetting behavior on the base plate and battery components; (vii) the absence of contaminants (e.g., unreacted materials, low molecular weight materials) or volatile components; and (viii) the absence of air inclusions and gas or bubble formation.

In car battery applications, the gap filler may need to provide stability in the range of −40° C. to 90° C. The gap filler may further need to provide the desired deformation and recovery (e.g., low hardness) needed to withstand charging and discharging processes, as well as travel over varying road conditions. In some embodiments, a Shore A hardness of no greater than 90, e.g., no greater than 80, or even no greater than 70 may be desired. Also, as repair and replacement may be important, in some embodiments, the polymer should permit subsequent cure and bonding of additional layers, e.g., multiple layers of the same thermally-conducting gap filler.

Aziridino-functional polyether polymers provide a good balance of the desired properties. Generally, the polyether backbone provides both the desired uncured rheological properties as well as the desired cured mechanical and thermal properties, while allowing the necessary filler loadings to achieve adequate thermal conductivity.

Polyethers to be used may be chosen based upon on a variety of factors, including the desired thermal and mechanical properties. Polyether generally refer to polymers having ether groups in their main chain (as opposed to side chains). Suitable polyethers for use in the present disclosure include aliphatic polyethers. Such polyethers include straight and branched alkylene groups connected through the ether linkages. In some embodiments, the alkylene groups have 1 to 6 carbon atoms, e.g., 2 to 4 carbon atoms.

The polyether may be a homopolymer having repeat units of only a single alkylene group or a copolymer of two or more alkylene groups. Such copolymers may be block copolymers, multi-block copolymers, alternating copolymers, or random copolymers.

Such copolymers can show homogenous or gradient distributions of the monomers along the chain. In some embodiments, the copolymers may contain blocks of homopolymer, blocks of random copolymers, blocks of alternating copolymers, and combinations thereof.

The polyether blocks may be selected from polytetrahydrofuran, polypropylene oxide, polyethylene oxide, copolymers of ethyleneoxide and tetrahydrofuran, copolymers of propylene oxide and tetrahydrofuran, copolymers of ethylene oxide and propylene oxide, block copolymers of ethylene oxide and propylene oxide and random terpolymers of ethylene oxide, propylene oxide, and tetrahydrofuran.

The polyethers may be prepared by the polymerization or copolymerization of cyclic ethers. Suitable cyclic ethers include, e.g., oxirane, alkyl-oxiranes (e.g., methyl-oxirane and ethyl-oxirane), substituted alkyl-oxiranes (e.g., chloro-methyl-oxirane, hydoxymethyl-oxiranes, alkoxyalkyl-oxiranes, and phenoxyalkyl-oxiranes), oxetane, tetrahydrofurane, and substituted tetrahydrofuranes, e.g., 3-methyl-tetrahydrofurane.

A polyether prepolymer of the general formula consisting of one, two three or more different repeating units is:

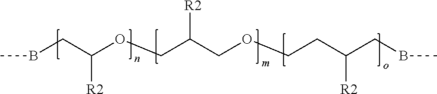

wherein: B is O or NR4;

R4 is H, a C₁ to C₁₂-Alkyl, a C₂ to-C₁₂-Alkenyl, or an Aryl;

each R2 is independently selected from H, alkyl (e.g., methyl, ethyl), substituted alkyl (e.g., chloromethly, hydroxymethyl), and phenyl; and n, m, and o are integers.

Integers m, n, and o may be independently selected and may be zero, provided that at least one is not zero, and these values are selected such that the resulting molecular weight meets the desired conditions. In some embodiments, n, m, and o are selected such that the molecular weight is at least 2000 grams per mole, e.g., at least 3000, or even at least 5000 grams per mole. In some embodiments, n, m, and o are selected such that the molecular weight is no greater than 20,000 grams per mole, e.g., no greater 15,000 grams per mole, e.g., no greater than 10,000 grams per mole. In some embodiments, n, m, and o are selected such that the molecular weight is between 2000 and 20,000 grams per mole, e.g., between 3000 and 15,000 grams per mole, between 3000 and 10,000 grams per mole, where all ranges are inclusive of the end points.

Aziridino functional (sometime referred to as aziridinyl functional) organic moieties are attached to backbones containing oxygen atoms in the main chain. In some embodiments, the aziridino functional group is of the formula:

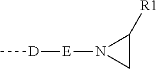

wherein: D is selected from C(═O)O, C(═O)NR5, C(═O), C(═O)C(═O)N(R5), C(═O)(CH₂)ₚ(C(═O), C(═S)NR5, and CH₂;

E is an alkylene group; and

R1 is H, a C₁ to C₁₂-Alkyl, a C₂ to C₁₂-Alkenyl, or an Aryl;

R5 is H, a C₁ to C₁₂-Alkyl, a C₂ to C₁₂-Alkenyl, or an Aryl; and

p is an integer.

In some embodiments, R1 is H-, Methyl-, Ethyl-, Ethenyl-, Propenyl-, Phenyl-, or Tolyl- .

Exemplary aziridino functional groups include:

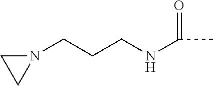

where: D=C(═O)NR5 (with R5═H); E=1,3-propandiyl;

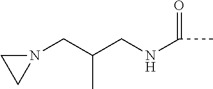

where: D=C(═O)NR5 (with R5═H); E=2-methyl-1,3-propandiyl;

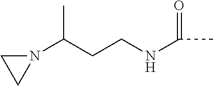

where: D=C(═O)NR5 (with R5═H); E=1,3-butandiyl;

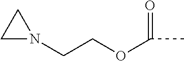

where: D=C(O)O; E=1,2-ethandiyl;

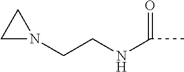

where: D=C(O)O; E=1,2-ethandiyl;

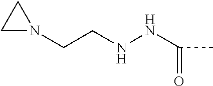

where: D=C(O)NH; E=2-aza-1,4-butandiyl;

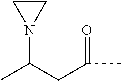

where: D=C(O); E=2-methyl-1,2-propandiyl;

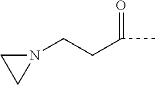

where: D=C(O); E=1,2-ethandiyl;

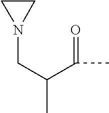

where: D=C(O); E=1-methyl-1,2-propandiyl;

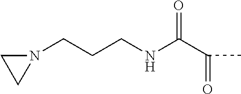

where: D=C(═O)C(═O)NR5 (with R5═H); E=1,3-propandiyl;

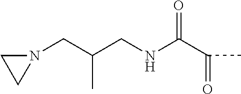

where: D=C(═O)C(═O)NR5 (with R5═H); E=2-methyl-1,3-propandiyl; and

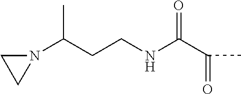

where: D=C(═O)C(═O)NR5 (with R5═H); E=1,3-butandiyl.

The aziridino groups may attached to the polyether backbone through any of a variety of divalent linking groups. For example, they may be attached through carbonate-, urethane-, urea-, ester- ether- or other linkages.

In some instances, the resulting aziridino-functional polyether has the general formula:

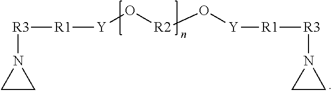

wherein: R3 is a straight chain or branched alkylene group, e.g., having 1 to 8 carbon atoms;

R1 is a covalent bond or an alkylene group;

each R2 is independently selected from the group consisting of alkylene groups;

Y is a divalent linking group;

and n is an integer selected to achieve the desired molecular weight of the polyether.

For example, in some instances, the resulting aziridino-functional polyether has the general formula:

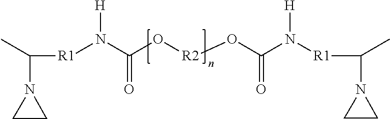

wherein: R1 is a covalent bond or an alkylene group; each R2 is independently selected from the group consisting of alkylene groups; and n is an integer selected to achieve the desired molecular weight of the polyether.

In some embodiments, n is selected such that the molecular weight is at least 2000 grams per mole, e.g., at least 3000, or even at least 5000 grams per mole. In some embodiments, n is selected such that the molecular weight is no greater than 20,000 grams per mole, e.g., no greater 15,000 grams per mole, e.g., no greater than 10,000 grams per mole. In some embodiments, n is selected such that the molecular weight is between 2000 and 20,000 grams per mole, e.g., between 3000 and 15,000 grams per mole, between 3000 and 10,000 grams per mole, where all ranges are inclusive of the end points.

In some embodiments, R1 is an alkylene group having 1 to 4 carbon atoms, e.g., 2 carbon atoms. The alkylene groups may be straight chain or branched alkylene groups.

Generally, the R2 groups may be selected independently from the R1 group. Therefore, any selection of the R2 groups may be combined with any selection of the R1 group.

In some instances, each R2 is independently selected from the group consisting of straight chain and branched alkylene groups having 1 to 6 carbon atoms, e.g., 2 to 4 carbon atoms.

In some instances, the R2 groups comprise alkylene groups having three carbon atoms.

In some instances, each of the R2 groups is an alkylene groups having three carbon atoms.

In some instances, the aziridino-functional polyether has the general formula:

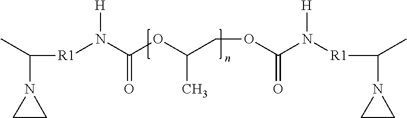

wherein R1 and n are as previously described. For example, in some embodiments, R1 is an alkylene group having two carbon atoms.

In some embodiments, the R2 groups are selected to produce a copolymer, e.g., a random copolymer of two or more different alkylene groups connected by the ether linkages. In some embodiments, such copolymers include both alkylene groups having two carbon atoms and alkylene groups having four carbon atoms.

For example, in some embodiments, the aziridino-functional polyether has the general formula:

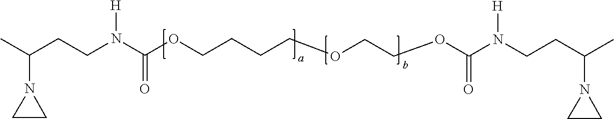

wherein: a and b are integers, and the sum of a and b equals n, which has been described herein. Although the R1 groups are show as ethylene groups, other alkylene groups may be used. It is understood that the polymer can be a block copolymer, a random copolymer or any other arrangement of repeating units.

In some embodiments, the control cure thermally-conductive gap fillers of the present disclosure comprise a single aziridino-functional polyether. In some embodiments, two or more different aziridino-functional polyethers may be combined.

Generally, any known thermally conductive fillers may be used, although electrically insulting fillers may be preferred where breakthrough voltage is a concern. Suitable electrically insulating, thermally conductive fillers include ceramics such as oxides, hydrates, silicates, borides, carbides, and nitrides. Suitable oxides include, e.g., silicon oxide and aluminum oxide. Suitable nitrides include, e.g., boron nitride. Suitable carbides include, e.g., silicon carbide. Other thermally conducting fillers include graphite and metals such as aluminum. Through-plane thermal conductivity is most critical in this application. Therefore, in some embodiments, generally symmetrical (e.g., spherical fillers) may be preferred, as asymmetrical fibers, flakes, or plates may tend to align in the in-plane direction.

To aid in dispersion and increase filler loading, in some embodiments, the thermally conductive fillers may be surface-treated or coated. Generally, any known surface treatments and coatings may be suitable.

Control cure thermally-conductive gap fillers should provide flame retardancy. In some embodiments, the present compositions meet the flame retardancy requirements of the standard UL-94 (V2, V1 or V0 performance achievement).

Thermally-conductive gap fillers include solid flame retardant additives that may use intumescent materials (e.g., expandable graphite and phosphorous compounds). Other solid flame retardant additives include aluminum hydroxide compounds (for instance, Aluminum trihydroxide). Specific solid flame retardant materials include those selected from the group consisting of an intumescent material, an aluminum hydroxide, and combinations thereof. Specifically, the intumescent material may be selected from the group consisting of phosphorous and expandable graphite. Furthermore, when the thermally-conductive gap filler is a phosphorous material, it may be selected from red phosphorous and white phosphorous.

It may be advantageous to use liquid flame retardant plasticizer such as a phosphoric acid alkyl ester. When used, this liquid flame retardant plasticizers may be used as the only flame retardant in the formulation, or may be used in combination with solid flame retardant materials. Useful liquid flame retardant plasticizer include those having the general formula OP(OR1)(OR2)(OR3), wherein each of R1, R2 and R3 is independently selected from a C1-C10 aliphatic group (no aromatic ring) and a C6-C20 aryl group, a C7-C30 alkylaryl group, and a C7-C30 arylalkyl group. Such liquid flame retardant plasticizers include, for instance, 2-ethylhexyldiphenyl phosphate.

Surprisingly, the applicants have determined that if a zinc tosylate is prepared in the presence of a molar excess of zinc oxide to para-toluenesulfonic acid, then a curing agent is produced comprising zinc tosylate deposited onto a particle of zinc oxide. When a thermally-conductive gap filler is prepared using this curing agent, it is an easy-to-handle, efficient curing, control cure thermally-conductive gap filler.

A further potential advantage is that by using a stoichiometric excess of zinc oxide, residual para-toluenesulfonic acid is minimized or eliminated from the system. It is possible that an excess of para-toluenesulfonic acid would be unstable and corrosive to packaging and/or battery systems.

Additionally, the preparation process described herein includes the reaction of zinc oxide with para-toluenesulfonic acid in solution (e.g., in a phosphoric acid alky ester which doubles as a plasticizing flame retardant). Ex situ preparation of zinc tosylate often involves the reaction in water, which can lead to water contaminated with zinc.

The present curatives may also be relatively easy to disperse in a matrix polymer.

The applicants have found that curing agents comprising zinc tosylate deposited onto a particle of zinc oxide can be prepared and used in-situ, which further simplifies the manufacturing process. In contrast, when the applicants attempted to synthesize and use stoichiometric zinc tosylate in-situ, the zinc tosylate formed on the reaction vessel walls, rendering them unusable as curing agents.

The curing agent comprising zinc tosylate deposited upon zinc oxide may have a major axis dimension of from 5 to 50 microns (which may be determined by such factors as the particle size of the starting zinc oxide material and the relative ratio of para-toluenesulfonic acid to zinc oxide).

The process for preparing a curing agent may comprise dispersing an amount of zinc oxide in a solvent to provide a dispersed zinc oxide. To the dispersed zinc oxide, an amount of para-toluenesulfonic acid is added to give a reaction mixture, which is then heated and stirred for a reaction period. This process is carried out wherein a ratio of the amount of zinc oxide to the amount of para-toluene sulfonic acid, in moles, is from 1 to 19, or 4 to 15, or more specifically from 4 to 10, or even more specifically, from 5 to 7.

The solvent may comprise a liquid flame retardant plasticizer, which might, for instance, be a phosphoric acid alkyl ester. Such phosphoric acid alky esters may have the general formula OP(OR1)(OR2)(OR3), wherein each of R1, R2 and R3 is independently selected from a C1-C10 aliphatic group (no aromatic ring), a C6-C20 aryl group, a C7-C30 alkylaryl group, and a C7-C30 arylalkyl group. One particular example of a useful solvent is 2-ethylhexyldiphenyl phosphate

The resulting curing agent comprises zinc tosylate deposited onto a particle of zinc oxide. The curing agent can have, for instance, a major axis dimension of from 5 to 25 microns.

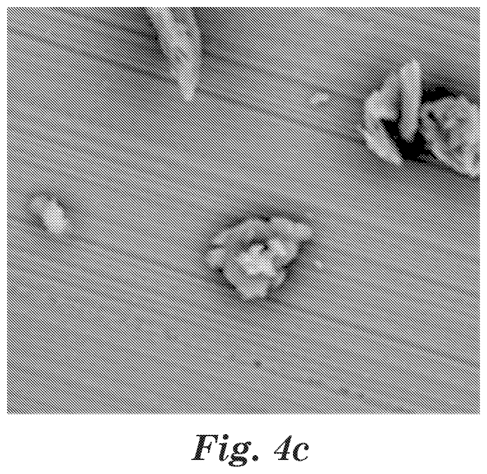

FIG. 4 contains a series of scanning electron microscope images. FIG. 4a shows a particle of zinc oxide, such as might be used as a starting material in the preparation of the curing agent described herein. FIG. 4b shows a curing agent made according to the present application, having zinc tosylate deposited onto a particle of zinc oxide. FIG. 4c shows stoichiometric zinc tosylate crystals.

When the present application refers to zinc tosylate deposited onto a particle of zinc oxide, this does not refer to a method step or a product by process description. It simply refers to the fact that, as shown in FIG. 4b, zinc tosylate crystals are physically on a zinc oxide particle. It may be that the zinc oxide particle serves as a site of nucleation for the formation of zinc tosylate, it might be that zinc tosylate is formed and then deposited onto the zinc oxide, or some other mechanism may be occurring to give the curing agents depicted in FIG. 4b. Unless otherwise explicitly delimited, the curing agents themselves are not limited by their method of making.

The process for preparing a control cure thermally-conductive gap filler composition may further comprise mixing the curing agent with a matrix polymer, in the presence of a thermally-conductive filler. The thermally-conductive filler may be mixed with the curing agent before mixing the curing agent with the matrix polymer, or it may be mixed with the matrix polymer before mixing the curing agent with the matrix polymer, or a first and second amount of thermally-conductive filler may be mixed into each of the curing agent and the matrix polymer before mixing the two parts together.

Control cure thermally-conductive gap filler compositions described herein comprise a matrix polymer, a thermally-conductive filler, and a curing agent. The curing agent may comprise zinc tosylate deposited onto a particle of zinc oxide. Further, the curing agent may have a major axis dimension of from 5 to 50 microns.

The control cure thermally-conductive gap filler composition of the present application may have a concentration of curing agent of from 0.1 to 5.0 percent, more particularly from 0.1 to 4.0 percent, from 0.1 to 3.5 percent, or even from 0.1 to 1.5 percent by weight based on the total weight of the initiator paste.

The control cure thermally-conductive gap filler composition of the present application may have a concentration of zinc tosylate of from 0.05 to 2.0 percent, from 0.1 to 2.0 percent, or even from 0.1 to 1.5 percent, by weight based on the total weight of the initiator paste.

In order to achieve low temperature, e.g., room temperature, cure without the need for actinic radiation, two-part systems may be preferred. In such systems, the initiator is in one part, often referred to as Part A, and the matrix polymer is in the second part, often referred to as Part B.

The non-reactive components may be distributed as desired between Parts A and B. In some embodiments, all the thermally-conductive fillers are in Part B with the matrix polymer. Alternatively, the thermally-conductive fillers may be present in both Parts A and B. It may be desirable to distribute the fillers such that the subsequent mixing of Parts A and B is made easier, e.g., by matching the viscosities of Parts A and B.

The present disclosure may be exemplified, for instance, in the following embodiments.

### Embodiment 1

Embodiments of the present disclosure are explained in more detail with the following non-limiting examples.

### EXAMPLES

The materials used in the following Examples are summarized in Table 1.

| Material | Reference | Source | Brief Description |
|---|---|---|---|
| APregon4 | MP1 | 3M Company | Propylene-glycol- |
| | | | bis-aziridino |
| | | | functionalized polymer |
| Acclaim Polyol 4200 | AP | Covestro | Polyetherpolyol |
| Santicizer 141 | FRP | Valtris | 2-ethylhexyldiphenyl |
| | | | phosphate |
| Silatherm Advance | ZnO | Quarzwerke | Zinc oxide |
| 1438-800 EST | | | |
| p-Toluenesulfonic | p-TSA | Aldrich | p-Toluenesulfonic acid |
| acid | | | monohydrate |
| Disperbyk-145 | DA | Byk | Phosphoric ester salt |
| | | | of high molecular |
| | | | weight copolymer |
| ABY6Y1-150 | TCF | Micron - | Spherical Aluminum |
| | | Nippon Steel | |
| Stoichiometric | S-ZnTos | 3M | Stoichiometric zinc |
| ZnTos | | | salt of p- |
| | | | Toluenesulfonic acid |

Curing Time Measurements

Curing time was measured using a Rheometer DHR 2 (TA Instruments), with a Plate/Plate of 25 mm, in oscillation mode (1 Hz) at 23° C. Curing time start was indicated in the rheometric curve when G′ and G″ began to increase.

Preparation of Initiator Premix

For preparation of initiator premix 1-7, 228 g FRP was added into a glass vessel. To the FRP was added an amount of ZnO, which was then dispersed for 5 minutes by stirring at 2000 rpm. While stirring, an amount of p-TSA was added and the mixture was stirred for another 5 minutes at 2000 rpm. Upon addition of the p-TSA, the pH of the mixture was between 2.0 and 2.5. next, 4.4 g of water was added and the mixture was stirred for a second 5 minute stirring period, after which the pH was approximately 6.0, indicating reaction of the p-TSA with ZnO.

The mixture was then heated to 75° C. for 15 minutes under stirring at 2000 rpm. The pH at the end of this heated stirring was approximately 6.5. The mixture was then cooled to provide an initiator premix.

Initiator premix 8 was powdered 1:2 stochiometric zinc tosylate.

TABLE 2
Summary of Initiator Premix Compositions

| Initiator | Mass Ratio | Mole Ratio | | |
|---|---|---|---|---|
| Premix | p-TSA : ZnO | ZnO : p-TSA | ZnO (g) | pH |
| IP 1 | 0.333 | 7.0 | 24 | 6.5 |
| IP 2 | 0.444 | 5.3 | 36 | 6.5 |
| IP 3 | 0.222 | 10.5 | 32 | 6.5 |
| IP 4 | 0.218 | 10.7 | 14.2 | 6.5 |
| IP 5 | 0.442 | 5.3 | 66 | 6.5 |
| IP 6 | 0.204 | 11.5 | 61.3 | 6.5 |
| IP 7 | 0.333 | 7.0 | 48 | 6.5 |
| IP 8 | | | N-A | 5.6 |

Preparation of Initiator Paste

The initiator premix was shaken by hand to homogenize. Into a speedmixer cup, 10 g of initiator premix was added. Then 0.05 g DA was added. Then 43 g of TCF was added and the material was mixed for 30 seconds. Then another 43 g of TCF was added, the material was again mixed for 30 seconds, to give an initiator paste. The initiator paste was then allowed to set for 24 hours.

Preparation of Base Component

The base component was prepared by mixing together 7.6 g MP1 with 2.3 g AP. Then 0.2 g of DA was added. Then 45 g of TCF was added and the material was mixed. Then another 45 g of TCF was added and the material was again mixed. The mixture was then degassed to avoid entrapped air.

Preparation of Thermally-Conductive Gap Filler

Thermally-conductive gap fillers were prepared by mixing 3 g of the base component with 3.12 g of an initiator paste. Mixing was done by hand for 1 minute. The samples were then subjected to curing time measurements. The results are shown in Table 3. The weight percentages provided are relative to the total weight of the initiator paste.

TABLE 3
Examples and Results

| | | | | Curing | Pot | Curing |
|---|---|---|---|---|---|---|
| | | ZnO | ZnTos | Agent | Life | Time |
| Example | Initiator | (wt %) | (wt %) | (wt %) | (min) | (min) |
| Ex 1 | IP 1 | 0.94 | 0.34 | 1.22 | 22.5 | 45.5 |
| Ex 2 | IP 2 | 1.32 | 0.63 | 1.82 | 9.5 | 16.5 |
| Ex 3 | IP 3 | 1.36 | 0.32 | 1.61 | 51.5 | 72.5 |
| Ex 4 | IP 4 | 0.59 | 0.14 | 0.70 | 55.0 | 151.5 |
| Ex 5 | IP 5 | 2.10 | 0.99 | 2.89 | 3.0 | 9.5 |
| Ex 6 | IP 6 | 2.08 | 0.63 | 2.62 | 13.5 | 21.5 |
| Ex 7 | IP 7 | 1.68 | 0.60 | 2.17 | 25.0 | 51.5 |
| Ex 8 | IP 8 | 0.85 | 1.18 | 2.03 | | 20 |

Various modifications and alterations of this invention will become apparent to those skilled in the art without departing from the scope and spirit of this invention.

1. A control cure thermally-conductive gap filler composition comprising a matrix polymer, a thermally-conductive filler, and a curing agent comprising zinc tosylate deposited onto a particle of zinc oxide.

2. The control cure thermally-conductive gap filler composition of claim 1, wherein the curing agent has a major axis dimension of from 5 to 50 microns.

3. The control cure thermally-conductive gap filler composition of claim 1, comprising an initiator paste that comprises the curing agent and the thermally-conductive filler and a base component that comprises the matrix polymer, wherein the concentration of curing agent in the initiator paste is from 0.1 to 5.0 percent by weight based on the total weight of the initiator paste.

4. (canceled)

5. (canceled)

6. The control cure thermally-conductive gap filler composition of claim 1, comprising an initiator paste that comprises the curing agent and the thermally-conductive filler and a base component that comprises the matrix polymer, wherein the concentration of zinc tosylate in the initiator paste is from 0.05 to 2.0 percent by weight based on the total weight of the initiator paste.

7. (canceled)

8. (canceled)

9. The control cure thermally-conductive gap filler composition of claim 1, wherein the matrix polymer comprises at least one aziridino-functional polyether polymer.

10. The control cure thermally-conductive gap filler composition of claim 9, wherein the at least one aziridino-functional polyether polymer has the formula: 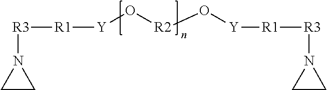
wherein: R1 is a covalent bond or an alkylene group;
each R2 is independently selected from the group consisting of alkylene groups;
R3 is a straight chain or branched alkylene groups;
Y is a divalent linking group;
and n is an integer selected such that the calculated molecular weight of the polyether polymer is between 2000 and 10,000 grams per mole.

11. The control cure thermally-conductive gap filler composition of claim 10, wherein the at least one polyether polymer has the formula:

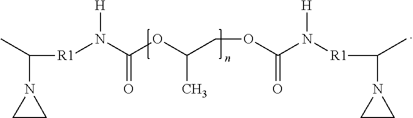

12. The control cure thermally-conductive gap filler composition of claim 11, wherein each R2 is independently selected from the group consisting of linear alkylene groups having 2 to 6 carbon atoms.

13. The control cure thermally-conductive gap filler composition of claim 1, wherein the thermally-conductive gap filler comprises at least 50% by volume of the thermally-conductive filler based on the total volume of the thermally-conductive gap filler.

14. (canceled)

15. The control cure thermally-conductive gap filler composition of claim 1, further comprising a flame retardant plasticizer.

16. The control cure thermally-conductive gap filler composition of claim 15, wherein the liquid flame retardant plasticizer has the general formula OP(OR1)(OR2)(OR3), wherein each of R1, R2 and R3 is independently selected from a C1-C10 aliphatic group, a C6-C20 aryl group, a C7-C30 alkylaryl group, and a C7-C30 arylalkyl group.

17. The control cure thermally-conductive gap filler composition of claim 16, wherein the liquid flame retardant plasticizer is 2-ethylhexyldiphenyl phosphate.

18. A battery module comprising a plurality of battery cells connected to a first base plate by a first layer of a first thermally-conductive gap filler according to claim 1.

19. A process for preparing a curing agent comprising:
dispersing an amount of zinc oxide in a solvent to provide a dispersed zinc oxide;
adding an amount of para-toluene sulfonic acid to the dispersed zinc oxide to give a reaction mixture; and
heating and stirring the reaction mixture for a reaction period
wherein a ratio of the amount of zinc oxide to the amount of para-toluene sulfonic acid, in moles, is from 4 to 15.

20. The process of claim 19, wherein the solvent comprises a liquid flame retardant plasticizer.

21. The process of claim 20, wherein the liquid flame retardant plasticizer is a phosphoric acid alkyl ester.

22. The process of claim 21 wherein the phosphoric acid alkyl ester has the general formula OP(OR1)(OR2)(OR3), wherein each of R1, R2 and R3 is independently selected from a C1-C10 aliphatic group (no aromatic ring) and a C6-C20 aryl group, a C7-C30 alkylaryl group, and a C7-C30 arylalkyl group.

23. The process of claim 22, wherein the liquid flame retardant plasticizer is 2-ethylhexyldiphenyl phosphate

24. A process for preparing a control cure thermally-conductive gap filler composition, comprising preparing a curing agent according to claim 19, and further;
mixing the curing agent with a matrix polymer, in the presence of a thermally conductive filler.

25. The process of claim 24, further comprising mixing the thermally-conductive filler with the curing agent before mixing the curing agent with the matrix polymer.
